(19) United States
(12) Patent Application Publication
(10) Pub. No.: US 2024/0281724 A1
(43) Pub. Date: Aug. 22, 2024

(54) SALES SUPPORT DEVICE, SALES SUPPORTING METHOD, AND STORAGE MEDIUM

(71) Applicant: NEC Corporation, Minato-ku, Tokyo (JP)

(72) Inventor: Yasuhiro Ajiro, Tokyo (JP)

(73) Assignee: NEC Corporation, Minato-ku, Tokyo (JP)

(21) Appl. No.: 18/567,139

(22) PCT Filed: Jun. 11, 2021
(86) PCT No.: PCT/JP2021/022263

§ 371 Date: Dec. 5, 2023

(51) Int. Cl. G06Q 10/00

(52) U.S. Cl. CPC G06Q 10/00

(57) ABSTRACT

To more accurately determine condition of a business negotiation, a sales support apparatus (10) includes: an obtaining section (11) obtaining a first document in which contents of a first business negotiation are described in a natural language; a selection section (12) that refers, for each second business negotiation other than the first business negotiation, to a storage device storing: a second document in which contents of the second business negotiation are described in a natural language; information on a cluster to which the second document belongs; and a business negotiation condition indicated in a document belonging to the cluster, and selects a cluster from among clusters formed in clustering of the second documents, based on a degree of similarity between the first document and the second documents; and an output section (13) outputting information indicative of condition of a business negotiation, associated with the selected cluster.

### TECHNICAL FIELD

The present invention relates to sales support apparatuses, sales supporting methods, and programs.

### BACKGROUND ART

A technique for analyzing, for example, data regarding a contract with a customer has been proposed. Patent Literature 1 discloses a data analyzing system for searching a combination of explanatory variables for accurately predicting a target variable. The data analyzing system disclosed in Patent Literature 1 searches a combination of an explanatory variable, which include an attribute value indicative of attributes of the customer such as the gender, the age group, the period of contract, and a presence of subscription to options, and a target variable, which is an attribute value indicating whether the customer continues or cancels the contract.

### CITATION LIST

### Patent Literature

### Patent Literature 1

Japanese Patent Application Publication Tokukaihei No. 2016-4525

### SUMMARY OF INVENTION

### Technical Problem

The progress of a business negotiation depends not only on the customer's attribute values, but on various factors associated with the business negotiation, such as specific sales activities carried out by a sales representative. However, it is difficult to determine, by the technique disclosed in Patent Literature 1, the condition of a business negotiation taking into consideration various factors associated with the business negotiation.

An example aspect of the present invention is accomplished in view of these problems, and an example object thereof is to provide a technique that more accurately determine the condition of a business negotiation.

### Solution to Problem

A sales support apparatus in accordance with an example aspect of the present invention includes: obtaining means that obtains a first document in which contents of a first business negotiation are described in a natural language; selection means that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and output means that outputs information indicative of a condition of a business negotiation, the information being associated with the cluster selected by the selection means.

A sales supporting method in accordance with an example aspect of the present invention includes: obtaining, by the sales support apparatus, a first document in which contents of a first business negotiation are described in a natural language; by the sales support apparatus, referring, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selecting a cluster from among multiple clusters formed in clustering of the second documents, on the basis of a degree of similarity between the first document and each of at least one or all of the second documents; and outputting, by the sales support apparatus, information indicative of a condition of a business negotiation, the information being associated with the cluster selected by the selection means.

A program in accordance with an example aspect of the present invention is a program for causing a computer to function as a sales support apparatus, the program causing the computer to function as: obtaining means that obtains a first document in which contents of a first business negotiation are described in a natural language; selection means that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and output means that outputs information indicative of a condition of a business negotiation, the information being associated with the cluster selected by the selection means.

### Advantageous Effects of Invention

According to an example aspect of the present invention, it is possible to more accurately determine the condition of a business negotiation.

### BRIEF DESCRIPTION OF DRAWINGS

FIG. 1 is a block diagram illustrating the configuration of a sales support apparatus in accordance with a first example embodiment of the present invention.

FIG. 2 is a flowchart illustrating the flow of a sales supporting method in accordance with the first example embodiment of the present invention.

FIG. 3 is a block diagram illustrating the configuration of a business negotiation management system in accordance with a second example embodiment of the present invention.

FIG. 4 is a table showing a specific example of a business negotiation record database in accordance with the second example embodiment of the present invention.

FIG. 5 is a table showing a specific example of a description table in accordance with the second example embodiment of the present invention.

FIG. 6 is a flowchart illustrating the flow of a sales supporting method in accordance with the second example embodiment of the present invention.

FIG. 7 is a table showing a specific example of clusters in accordance with the second example embodiment of the present invention.

FIG. 8 is a block diagram illustrating the configuration of a computer that functions as sales support apparatuses or user terminals in accordance with the first to fourth example embodiments of the present invention.

### EXAMPLE EMBODIMENTS

### First Example Embodiment

The following description will discuss in detail a first example embodiment of the present invention with reference to the drawings. The present example embodiment is a basic form of example embodiments described later.

### <Configuration of Sales Support Apparatus>

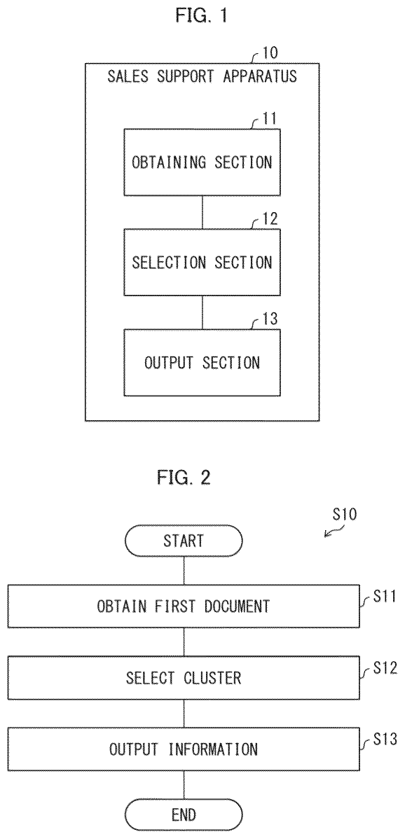

The following description will discuss the configuration of a sales support apparatus 10 in accordance with the present example embodiment with reference to FIG. 1. FIG. 1 is a block diagram illustrating the configuration of the sales support apparatus 10. The sales support apparatus 10 includes an obtaining section 11, a selection section 12, and an output section 13. The obtaining section 11 is an example configuration that realizes obtaining means recited in the claims. The selection section 12 is an example configuration that realizes selection means recited in the claims. The output section 13 is an example configuration that realizes output means recited in the claims.

The obtaining section 11 obtains a first document in which the contents of a first business negotiation are described in a natural language. The selection section 12 refers, for each of multiple second business negotiations that are other than the first business negotiation, to a storage device storing: a second document in which the contents of the second business negotiation are described in a natural language; information on a cluster to which the second document belongs; and a business negotiation condition indicated in a document belonging to the cluster, and the selection section 12 selects a cluster from among multiple clusters formed in clustering of the second documents, on the basis of a degree of similarity between the first document and each of at least one or all of the second documents. The output section 13 outputs information indicative of the condition of a business negotiation, the information being associated with the cluster selected by the selection section 12. Note that examples of the document as used herein may include a sales daily report and a meeting record of a sales activity, and the document only needs to be one that includes the contents of a business negotiation.

Herein, the business negotiation refers to the exchange of various kinds of information as to a target matter between a person in charge belonging to a company, a business store, or the like, who provides a service or a product, and a customer. The business negotiation may be conducted face-to-face or may be conducted non-face-to-face via a network, a telephone, or the like. In a case of non-face-to-face, an interview may be conducted in real time (e.g., chat, on-line meeting) or may be conducted in non-real time (e.g., email, etc.). The number of persons in charge and the number of customers may each be one or more. The person in charge and the customer may be a robot, software, or the like.

The document includes the contents of the business negotiation described in a natural language. An example of the document may be a daily report created by a sales representative. Examples of the natural language may include Japanese, Chinese, and English. In the following description, for convenience of description, data indicative of a document is also simply referred to as a “document”. Examples of the document may include: text data indicating a character string indicative of the contents of a business negotiation; a file created by a predetermined word processing software; a file in PDF format, and a file in HTML format. The document may be, for example, data generated by a user operating an input device or the like, or alternatively, the document may be, for example, data generated by a device such as the sales support apparatus 10, executing a voice analysis process on a voice file indicative of the contents of a business negotiation.

Each of the multiple clusters includes one or more second documents. For example, the multiple second documents may be divided into multiple clusters by clustering performed in advance.

### <Flow of Sales Supporting Method>

The following description will discuss a flow of a sales supporting method S10 in accordance with the present example embodiment with reference to FIG. 2. FIG. 2 is a flowchart illustrating the flow of the sales supporting method S10.

### (Step S11)

In step S11 (obtaining process), the obtaining section 11 obtains a first document in which the contents of a first business negotiation are described in a natural language. For example, the obtaining section 11 may obtain the first document from a device communicatively connected via a network, or alternatively, the obtaining section 11 may obtain the first document by loading it from a memory.

### (Step S12)

In step S12 (selection process), the selection section 12 refers, for each of multiple second business negotiations that are other than the first business negotiation, to a storage device storing a second document in which the contents of the second business negotiation are described in a natural language, and the selection section 12 selects a cluster from among multiple clusters formed in clustering of the second documents, on the basis of the degree of similarity between the first document and each of at least one or all of the second documents.

As a method of determining similarity between documents, the selection section 12 may, for example, use a method of calculating a distance in a predetermined feature space between words included in the documents. In this case, the selection section 12 calculates the degree of similarity between a first document and a second document on the basis of the distance between a word included in the first document and a word included in the second document. In this case, the degree of similarity decreases as the distance between the documents increases, and increases as the distance between the documents decreases. Note that a process of calculating the degree of similarity between the first document and the second document is not limited to the one described in the foregoing.

For example, as a method of selecting a cluster from among the multiple clusters, the selection section 12 may select one or more second documents such that the degree of similarity to the first document satisfies a predetermined condition, and select a cluster to which at least one or all of the one or more selected second documents belong, from among the multiple clusters. Further, for example, the selection section 12 may calculate, for each of the multiple clusters, the degree of similarity to a second document representative of the cluster, and select a cluster on the basis of the calculated degrees of similarity of the clusters. Note that a process of selecting a cluster is not limited to the one described in the foregoing.

### (Step S13)

In step S13 (output process), the output section 13 outputs information indicative of the condition of a business negotiation, associated with the cluster selected by the selection section 12. For example, the output section 13 may output the information to a device communicatively connected via a network, or alternatively, may output the information by writing the information into a memory.

As described in the foregoing, the sales support apparatus 10 in accordance with the present example embodiment employs a configuration in which, on the basis of the degree of similarity between the first document describing the contents of the first business negotiation and each of the second documents describing the second business negotiations, a cluster is selected from among the multiple clusters formed in clustering of the second documents, and information associated with the selected cluster is outputted. Since the selection of a cluster is performed on the basis of the similarity between documents in each of which the contents of a business negotiation are described in a natural language, it is possible to achieve, by the sales support apparatus 10 in accordance with the present example embodiment, an example advantage of more accurately determining the condition of a business negotiation.

### Second Example Embodiment

The following will discuss in detail a second example embodiment of the present invention, with reference to drawings. Note that any constituent element that is identical in function to a constituent element described in the first example embodiment will be given the same reference numeral, and a description thereof will not be repeated.

### <Configuration of System>

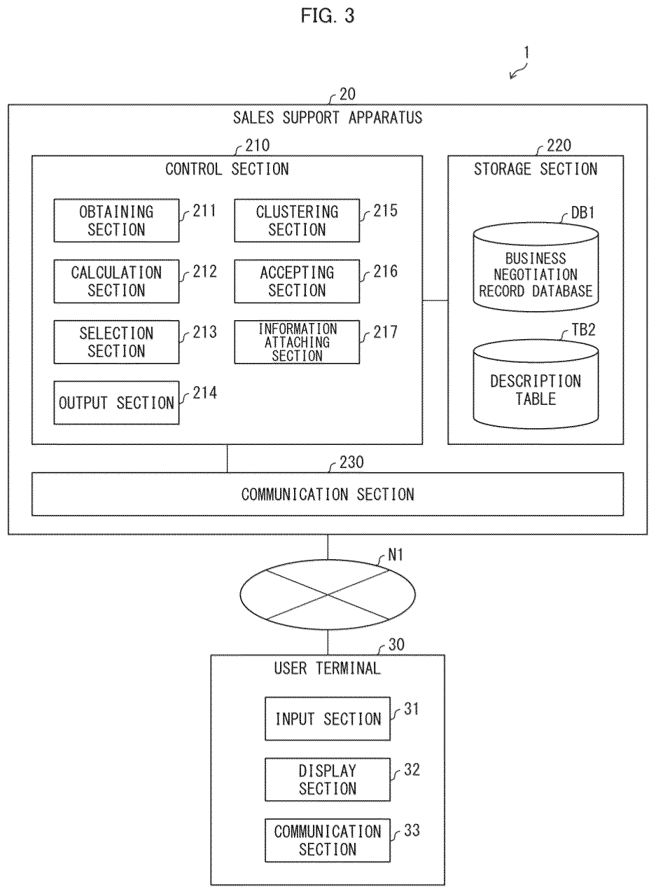

FIG. 3 is a block diagram illustrating the configuration of a business negotiation management system 1 in accordance with the present example embodiment. The business negotiation management system 1 is a system that manages business negotiations conducted by sales representatives and the like. The business negotiation management system 1 includes a sales support apparatus 20 and a user terminal 30. The sales support apparatus 20 and the user terminal 30 are communicatively connected to each other via a network N1. Note that although FIG. 3 illustrates a single user terminal 30, the number of user terminals 30 to which the sales support apparatus 20 is connected is not limited thereto. Examples of the network N1 may include a wireless local area network (LAN), a wired LAN, a wide area network (WAN), a public network, a mobile data communication network, or a combination of these networks. Note that the configuration of the network N1 is not limited to these examples.

### <Configuration of Sales Support Apparatus>

The sales support apparatus 20 is an apparatus that outputs information on the condition of a business negotiation. The sales support apparatus 20 includes a control section 210, a storage section 220, and a communication section 230. The control section 210 includes an obtaining section 211, a calculation section 212, a selection section 213, an output section 214, a clustering section 215, an accepting section 216, and an information attaching section 217. The obtaining section 211 is an example configuration that realizes obtaining means recited in the claims. The calculation section 212 and the selection means 213 constitute an example configuration that realizes selection means recited in the claims. The output section 214 is an example configuration that realizes output means recited in the claims. The clustering section 215 is an example configuration that realizes clustering means recited in the claims. The accepting section 216 is an example configuration that realizes accepting means recited in the claims. The information attaching section 217 is an example configuration that realizes information attaching means recited in the claims.

In the present example embodiment, the information indicative of the condition of a business negotiation is information indicating what phase or condition the business negotiation is in. Examples of the condition of the business negotiation may include “selecting products”, “project delayed”, and “requirement mismatch”. The “selecting products” indicates that the business negotiation is in a phase of selection of products by the customer. The “project delayed” indicates a condition that the project is delayed. The “requirement mismatch” indicates that there is a mismatch between the customer's requirement and requirements of products or the like available to the customer. How a business negotiation progresses depends on specific contents of the business negotiation, such as sales contents of sales representatives. Examples of the contents of a business negotiation may include the contents of a material provided to a customer or the number of times interviews with a company officer are conducted.

An action recommended in a business negotiation may differ depending on the condition of the business negotiation. For example, when the condition of a business negotiation is “selecting products”, an action recommended may be, for example, to prepare benchmark materials. Further, for example, when the condition of a business negotiation is “project delayed”, an action recommended may be, for example, to involve a superior. Further, for example, when the condition of a business negotiation is “requirement mismatch”, an action recommended may be, for example, to pull out.

The storage section 220 is an example configuration that realizes a storage device recited in the claims. The storage section 220 stores a business negotiation record database DB1 and a description table TB2.

The business negotiation record database DB1 stores business negotiation record data indicating the record of each of multiple business negotiations. Hereinafter, a “business negotiation the business negotiation record data of which is accumulated in the business negotiation record database DB1” may also be simply referred to as a “business negotiation accumulated in the business negotiation record database DB1”. Examples of the multiple business negotiations accumulated in the business negotiation record database DB1 may include a past business negotiation or a business negotiation currently in progress. The past business negotiation may be, for example, a business negotiation the result of which has been confirmed. In the present example embodiment, among the multiple business negotiations accumulated in the business negotiation record database DB1, a business negotiation currently in progress is adopted as a first business negotiation. When there is accumulated multiple business negotiations currently in progress in the business negotiation record database DB1, at least one of them is adopted as a first business negotiation. Further, among the multiple business negotiations accumulated in the business negotiation record database DB1, business negotiations other than the first business negotiation are adopted as second business negotiations. The business negotiation record data includes a document in which the contents of a business negotiation are described in a natural language. That is, the business negotiation record database DB1 stores a document set (business negotiation record data of the first business negotiation) including one or more first documents in each of which the contents of the first business negotiation are described in a natural language. The business negotiation record database DB1 also stores a document set (business negotiation record data of the second business negotiations) including, for each of the multiple second business negotiations, one or more second documents in each of which the contents of the second business negotiation are described in a natural language.

In the following description, in a case where it is not necessary to distinguish between a first business negotiation and a second business negotiation for convenience of description, these may also be simply referred to as a “business negotiation” or “business negotiations”. Further, in a case where it is not necessary to distinguish between a first document and a second document, these may also be simply referred to as a “document” or “documents”.

The description table TB2 stores information of a cluster to which a second document belongs, and a business negotiation condition indicated in a document belonging to the cluster. For example, the description table TB2 may be a table in which the type of a cluster and information on the condition of a business negotiation are associated with each other. For example, the information on the condition of a business negotiation may include information indicative of the condition of the business negotiation and information indicative of an action recommended in the condition.

The obtaining section 211 obtains a first document in which the contents of a first business negotiation are described in a natural language, by loading the first document from the business negotiation record database DB1. The calculation section 212 refers to the business negotiation record database DB1 and calculates, for each of multiple second business negotiations, the degree of similarity between the first document and each of at least one or all of second documents. Details of a method of calculating the degree of similarity between a first document and a second document will be described later.

On the basis of the degrees of similarity calculated by the calculation section 212, the selection section 213 selects a cluster from among multiple clusters formed in clustering of the multiple second documents. Details of a method of selecting a cluster will be described later.

The output section 214 outputs the information on the condition of a business negotiation, associated with the cluster selected by the selection section 213. The clustering section 215 performs clustering on the second documents in accordance with the degrees of similarity between documents, to form multiple clusters. The accepting section 216 accepts input of the information on the condition of a business negotiation for each of the multiple clusters. The information attaching section 217 stores, in the storage section 220, the information accepted by the accepting section 216 in association with information for identifying the cluster.

The communication section 230 transmits and receives information to and from the user terminal 30 via the network N1, under the control of the control section 210. Hereinafter, a case where the control section 210 transmits and receives information to and from the user terminal 30 via the communication section 230 may simply be referred to as a case where the control section 210 transmits and receives information to and from the user terminal 30.

### <Configuration of User Terminal>

The user terminal 30 is a terminal that is used by a user. The user may be, for example, a sales representative who conducts a business negotiation. Examples of the user terminal 30 may include a laptop computer, a desktop computer, a tablet terminal, or a smartphone. The user terminal 30 includes an input section 31, a display section 32, and a communication section 33. The user terminal 30 is connected to an input device and a display device (both not illustrated). The input section 31 obtains, through the input device, a determination request of the condition of a first business negotiation. The input section 31 transmits the obtained determination request to the sales support apparatus 20. The display section 32 outputs information on the condition of the first business negotiation outputted by the sales support apparatus 20.

The communication section 33 transmits and receives information to and from the sales support apparatus 20 via the network N1. Hereinafter, a case where the communication section 33 transmits and receives information to and from the sales support apparatus 20 may be simply referred to as a case where the user terminal 30 transmits and receives information to and from the sales support apparatus 20.

### (Specific Example of Business Negotiation Record Database)

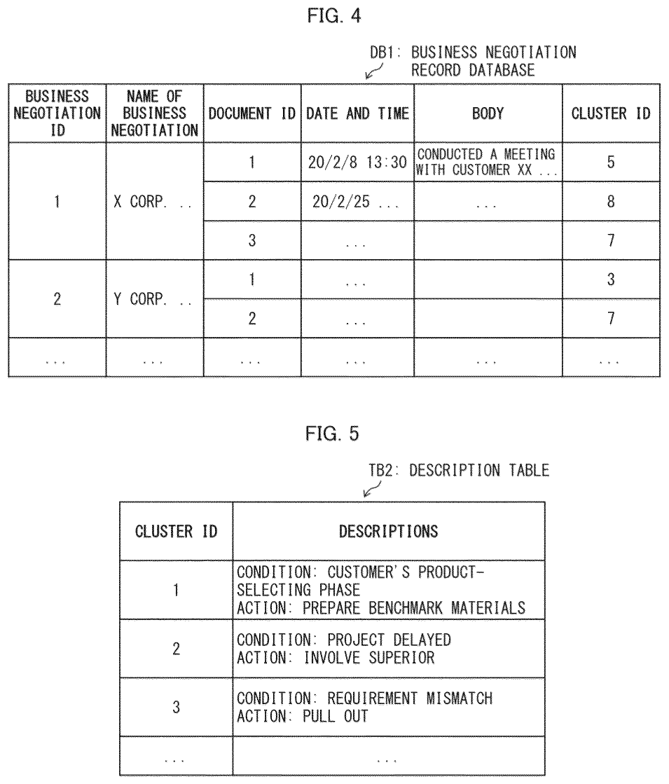

FIG. 4 is a table showing a specific example of the business negotiation record database DB1. In an example illustrated in FIG. 4, the business negotiation record database DB1 stores multiple types of business negotiation record data including items of “Business negotiation ID”, “Name of business negotiation”, “Document ID”, “Date and time”, “Body”, and “Cluster ID”. Of these items, the item “Business negotiation ID” stores business negotiation IDs. The business negotiation ID is identification information for identifying a business negotiation. The item “Name of business negotiation” stores text information for identifying a business negotiation, such as a customer name and a project name, which are targets of the business negotiation.

The item “Document ID” stores document IDs. The document ID is identification information for identifying a document in which the contents of a business negotiation are described in a natural language. The item “Date and time of report” stores information indicative of date and time at which a report is made. The date and time at which the report is made may be, for example, a date and time at which a document indicating the contents of a business negotiation is registered in the business negotiation record database DB1.

The item “Body” stores data indicating the contents of a document. Examples of the document indicating the contents of a document may include: text data; a file created by a predetermined word processing software; a file in PDF format, and a file in HTML format. Note that the item “Body” may also store an address indicative of a storage destination of data indicating the contents of a document.

The item “Cluster ID” stores identification information for identifying which cluster a second document concerned belongs to. The identification information for identifying a cluster may also referred to as a “cluster ID”.

In the example of FIG. 4, multiple documents are associated with a single business negotiation. With each of the multiple documents, information indicative of date and time is associated. The information indicative of date and time indicates, for example, date and time at which the document is created, or date and time at which a sales activity or the like described in the document as the contents is performed. That is, the multiple documents describing the contents of the single business negotiation have a rank order.

### (Specific Example of Description Table)

FIG. 5 is a table showing a specific example of the description table TB2. In the example of FIG. 5, the description table TB2 includes items of “Cluster ID” and “Description”. Of these items, the item “Cluster ID” stores the identification information for identifying clusters (cluster IDs). The item “Description” stores the information on the condition of a business negotiation associated with a corresponding cluster.

For example, the information on the condition of a business negotiation includes information indicative of the condition or the phase of a business negotiation such as “selecting products”, “project delayed”, and “requirement mismatch”. Further, the information on the condition of a business negotiation includes information indicative of an action recommended in the condition. For example, the information indicative of an action includes “prepare benchmark materials”, “involve superior”, and “pull out”.

### <Flow of Sales Supporting Method>

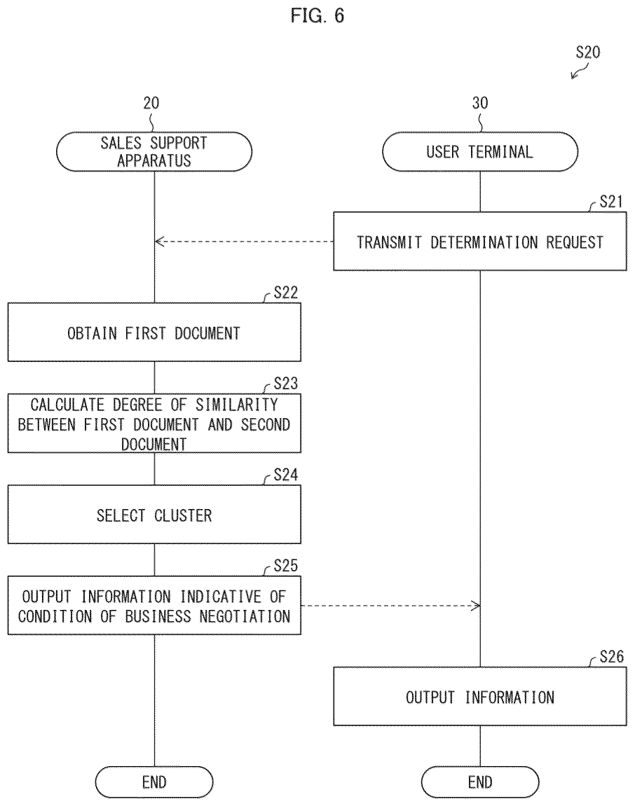

FIG. 6 is a flowchart illustrating the flow of a sales supporting method S20 carried out by the business negotiation management system 1. The sales supporting method S20 is a method of determining the condition of a first business negotiation specified by a user. For example, the sales supporting method S20 is started, triggered by a user carrying out an operation for requesting determination of the condition of a first business negotiation with use of an input device. For example, the user may specify the first business negotiation by inputting the identification information for identifying the first business negotiation through the input device, or the user may carry out an operation of specifying the target first business negotiation from among the multiple business negotiations through the input device. In the present example embodiment, the first business negotiation is a business negotiation registered in the business negotiation record database DB1. Note that the first business negotiation may be a business negotiation that is not registered in the business negotiation record database DB1.

### (Step S21)

The input section 31 of the user terminal 30 accepts information indicative of a determination request inputted through the input device. In step S21, on the basis of the information accepted by the input section 31, the communication section 33 transmits the determination request to the sales support apparatus 20. The determination request includes identification information for identifying the first business negotiation. The obtaining section 211 of the sales support apparatus 20 receives the determination request from the user terminal 30.

### (Step S22)

In step S22, the obtaining section 211 of the sales support apparatus 20 obtains a first document describing the contents of the first business negotiation, which is the target of the determination request received. Specifically, the obtaining section 211 reads out, from the business negotiation record database DB1, a first document corresponding to the identification information included in the determination request.

### (Step S23)

In step S23, the calculation section 212 calculates the degree of similarity between the first document obtained by the obtaining section 211, and each of at least one or all of multiple second documents included in business negotiation record data accumulated in the business negotiation record database DB1. For example, the calculation section 212 calculates, as the degree of similarity, the distance in a predetermined feature space between the first document and each of the multiple second documents.

### (Method of Calculating Degree of Similarity Between First Document and Second Document)

The following will describe specific examples of a method in which the calculation section 212 calculates the degree of similarity between the first document and the second document. The examples of the method includes: (a) a method based on inter-word distance; and (b) a method based on inter-document distance. Note that a method of determining similarity between the first document and the second document is not limited to these examples.

### (a: Method Based on Inter-Word Distance)

In a case where this method is employed, the calculation section 212 calculates the degree of similarity between the first document and the second document on the basis of distances between words included in the documents. Specifically, the calculation section 212 calculates an inter-word distance for each combination of a word included in the first document and a word included in the second document. For example, the calculation section 212 may carry out natural language processing for each of the first and second documents, and extracts words included in each document. For example, the natural language processing may be a morphological analysis or an N-gram analysis.

For example, the calculation section 212 calculates an inter-word distance for each combination of a word w1i (i=1, 2, . . . , n) included in the first document and a word w2j (j=1, 2, . . . , m) included in the second document. Herein, n and m are natural numbers. In this case, there are n×m combinations of the word w1i and the word w2j. In other words, the calculation section 212 calculates n×m inter-word distances. In a case where a feature of each word w1i and a feature of each word w2j are expressed in the form of vectors, an inter-word distance can be represented by an angle between the two vectors or by a Euclidean distance between the vectors. As a technique for expressing a feature of a word in the form of a vector, it is possible to use a trained model which has been trained by machine learning so as to output a feature vector upon receiving input of a word. A technique such as word2vec can be employed as such a trained model, although the present invention is not limited thereto.

The calculation section 212 calculates the degree of similarity between the first document and the second document, with use of a statistical value of inter-word distance. For example, the calculation section 212 calculates an average value of inter-word distances of all combinations of the words w1i and the words w2j as the degree of similarity indicative of the degree of similarity between the first document and the second document. In this case, the degree of similarity indicates that the greater the value of the degree of similarity is, the lower the degree of similarity is, and conversely, the smaller the value is, the higher the degree of similarity is. Further, for example, the calculation section 212 may select a predetermined number of combinations from among all combinations of the words w1i and the words w2j in ascending order of inter-word distances, and may then use, as the degree of similarity between the first document and the second document, an average value of inter-word distances for the selected combinations. Also in this case, the degree of similarity indicates that the greater the value of the degree of similarity is, the lower the degree of similarity is, and conversely, the smaller the value is, the higher the degree of similarity is.

### (b: Method Based on Inter-Document Distance)

In a case where this method is employed, the calculation section 212 calculates the degree of similarity between the first document and the second document on the basis of distances between the documents. In a case where a feature of each document is expressed in the form of a vector, an inter-document distance between the first document and the second document can be represented by an angle between the two vectors or by a Euclidean distance between the vectors. As a technique for representing a feature of a document in the form of a vector, it is possible to use a trained model that has been trained by machine learning so as to output a feature vector upon receiving input of a document. A technique such as doc2vec can be employed as such a trained model, although the present invention is not limited thereto.

The calculation section 212 may calculate the degree of similarity between the first document and the second document on the basis of the distance in the predetermined feature space between the first document and the second document, and the first calculation section 212 may use the distance in the predetermined feature space between the first document and the second document as the degree of similarity between the first document and the second document. In a case where the distance between the first document and the second document is used as the degree of similarity, the degree of similarity indicates that the greater the value is, the lower the degree of similarity is, and conversely, the smaller the value is, the higher the degree of similarity is.

### (Step S24)

In step S24 of FIG. 6, on the basis of the degrees of similarity between the first document and the multiple second documents calculated by the calculation section 212, the selection section 213 selects a cluster from among multiple clusters formed in clustering of the multiple second documents.

### (Method of Selecting Cluster)

The following will describe specific examples of a method of selecting a cluster by using the selection section 213. The examples of the method includes: (c) a method based on one or more second documents with the degree of similarity that satisfies a predetermined condition; and (d) a method based on the degree of similarity to a second document representing each cluster. Note that the method of selecting a cluster by using the selection section 213 is not limited to these examples.

(c: Method Based on One or More Second Documents with Degree of Similarity that Satisfies Predetermined Condition)

In a case where this method is employed, the selection section 213 selects one or more second documents such that the degree of similarity to the first document satisfies a predetermined condition, from among the multiple second documents, and then selects a cluster to which at least one or all of the one or more selected second documents belong from among the multiple clusters. Examples of the predetermined condition may include: a condition that the degree of similarity to the first document be the highest; a condition that the degree of similarity to the first document be not less than a predetermined threshold; and a condition that the rank of the degree of similarity to the first document be not less than a predetermined threshold.

As an example, the selection section 213 selects a second document that has the highest degree of similarity to the first document, from among the multiple second documents. Further, the selection section 213 selects a cluster to which the selected second document belongs, referring to the business negotiation record database DB1.

Further, as another example, the selection section 213 may select a cluster by the k-nearest neighbor algorithm. In this case, for example, the selection section 213 identifies k second documents as k nearest neighbors of the first document in a predetermined feature space, and selects a cluster that most frequently appears from among clusters to which the identified second documents belong.

### (d: Method Based on Degree of Similarity to Second Document Representative of Each Cluster)

In a case in which this method is employed, the calculation section 212 calculates the degree of similarity between the first document and a second document that is representative of each of the multiple clusters, and the selection section 213 selects a cluster, referring to the degree of similarity calculated by the calculation section 212. For example, the second document representative of each cluster is a second document with the smallest sum of the distances from all the other second documents included in the same cluster, that is, a second document located at the center or in the vicinity of the center of the cluster.

In this case, the selection section 213 refers to the business negotiation record database DB1 on the basis of the degree of similarity calculated by the calculation section 212, and selects a cluster to which the second document that has the highest degree of similarity belongs.

### (Step S25)

In step S25, the output section 214 outputs information indicative of the condition of a business negotiation, associated with the cluster selected by the selection section 213. In addition to the information indicative of the condition of the business negotiation, the information outputted from the output section 214 may include information indicative of an action recommended in the condition.

### (Step S26)

The user terminal 30 receives the information from the sales support apparatus 20. In step S26, the user terminal 30 outputs the information received from the sales support apparatus 20. For example, the user terminal 30 displays, on the display device, an image indicating image data received from the sales support apparatus 20. Since the determination result of the condition of the first business negotiation is displayed, the user can easily ascertain the current condition of the first business negotiation. Further, since the action recommended in the condition is displayed, the user can ascertain what action to take to move the business negotiation to the next phase.

### <Clustering and Registration Process of Information to Description Table>

Next, the following will describe clustering performed by the clustering section 215 and a registration process of information to the description table. The clustering section 215 performs clustering on multiple second documents in accordance with the degrees of similarity between documents, to form multiple clusters. In the present example embodiment, the clustering section 215 performs the clustering prior to the execution of the abovementioned sales supporting method S20.

For example, the clustering section 215 performs clustering on the second documents in accordance with the distances between second documents when the second documents are mapped in a predetermined feature space. At this time, for example, the clustering section 215 performs clustering by a hierarchical method such as the nearest neighbor method, or a non-hierarchical method such as the k-means clustering. Note that the method of performing clustering on second documents is not limited to these examples.

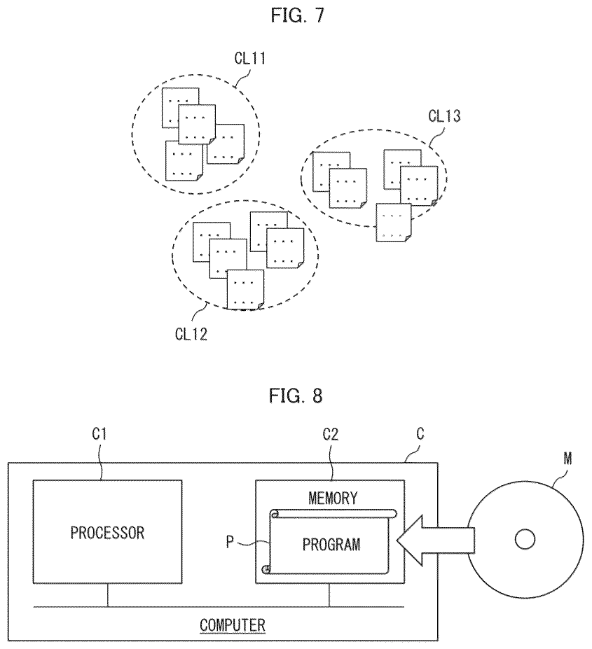

FIG. 7 is a table showing a specific example of a cluster formed by the clustering performed by the clustering section 215. In the example of FIG. 7, the clustering section 215 forms clusters CL11 to CL13 by performing clustering on multiple second documents. Each of the clusters CL11 to CL13 includes multiple second document.

The accepting section 216 accepts input of information on the condition of a business negotiation for each of the multiple clusters formed by the clustering section 215. The accepting section 216 may accept input of the information through an apparatus (e.g., user terminal 30) connected via the network.

When accepting input of the information through the user terminal 30, the accepting section 216 transmits information indicative of a result of the clustering performed by the clustering section 215 to the user terminal 30. Then, the user terminal 30 presents the information indicative of the result of the clustering to the user. For example, the information indicative of the result of the clustering indicates multiple clusters formed by the clustering section 215 and second documents included in each cluster. On the basis of the information presented by the user terminal 30, the user inputs information on the condition of a business negotiation to be associated with a corresponding one of the clusters by using the user terminal 30. For example, the user who inputs the information is an expert knowledgeable on business negotiations. The user terminal 30 transmits the inputted information to the sales support apparatus 20, and the accepting section 216 accepts the input of the information by receiving the information from the user terminal 30.

The information attaching section 217 stores, in the description table TB2, the information accepted by the accepting section 216, in association with information for identifying the cluster. Since the user such as an expert registers the information on the condition of a business negotiation for each cluster, the description table TB2 accumulates the information for each cluster. The information registered in the description table TB2 is referred to in the abovementioned sales supporting method S20.

### <Example Advantages of Present Example Embodiment>

As described in the foregoing, the present example embodiment employs a configuration in which the sales support apparatus 20 forms multiple clusters by performing clustering on multiple second documents in accordance with the degrees of similarity between documents. Since the sales support apparatus 20 selects a cluster on the basis of the similarity between the first document and the second document, it is possible to more accurately determine the condition of a business negotiation by using the sales support apparatus 20 in accordance with the present example embodiment.

Further, according to the present example embodiment, the sales support apparatus 20 accepts input of information on the condition of a business negotiation for each of the multiple clusters, and registers the accepted information to the description table TB2 in association with the cluster ID. Since information is attached to each cluster of second documents rather than to all the second documents registered in the business negotiation record database DB2, the sales support apparatus 20 in accordance with the present example embodiment can reduce the processing cost required in attaching information.

### <Variations>

In the present example embodiment, the obtaining section 211 may obtain a first document stored in a storage device other than the business negotiation record database DB1, instead of loading the first document from the business negotiation record database DB1. For example, such a storage device may be communicatively connected to the sales support apparatus 20 via a network, or alternatively, a portable storage medium readable by the sales support apparatus 20. Further, instead of loading the first document from the business negotiation record database DB1, the obtaining section 211 may obtain, as a first document, text information or the like inputted through the input device. In this case, the determination request inputted from the user terminal 30 in step S21 includes a first document in which the contents of the first business negotiation are described in a natural language. Further, in step S22, the obtaining section 211 may obtain, for example, the first document included in the received determination request.

### Third Example Embodiment

The following description will discuss in detail a third example embodiment of the present invention. Note that any constituent element that is identical in function to a constituent element described in the first example embodiment or the second example embodiment will be given the same reference numeral, and a description thereof will not be repeated.

In the present example embodiment, the obtaining section 211 obtains a first document set in which the contents of a first business negotiation are described in a natural language. The first document set includes a first document describing the contents of the first business negotiation, and one or more documents created before the first document is created, out of the other documents describing the contents of the first business negotiation. That is, the obtaining section 211 obtains third documents, which are created before the first document is created, regarding the first business negotiation.

The documents included in the first document set have a rank order; for example, the documents include information indicative of date and time. The information indicative of date and time indicates, for example, date and time at which the document is created, or date and time at which a sales activity or the like described in the first document as the contents is performed.

In the present example embodiment, the selection section 213 selects a cluster from among multiple clusters formed in clustering in which the second document set including second documents is mapped in a predetermined feature space. Each of the multiple second document sets subjected to clustering includes one or more documents, and one or more documents included in the second document set have the rank order. The one or more documents included in the second document set includes, for example, information indicative of date and time.

The second document set to be subjected to clustering in the present example embodiment includes a second document describing the contents of a second business negotiation, and one or more documents created before the second document is created, out of the other documents describing the contents of the second business negotiation. That is, the second documents are subjected to clustering with reference to each second document and a fourth document created regarding the same second business negotiation as the second document describes before the second document is created.

In the present example embodiment, the selection section 213 calculates the degree of similarity between a first document and a second document on the basis of the degree of similarity between a first document set including the first document and a second document set including the second document. That is, the selection section 213 calculates the degree of similarity between a first document and each second document on the basis of the degree of similarity between a first document set including the first document and a third document, and a second document set including the second document and a fourth document.

For example, the selection section 213 calculates the degree of similarity between a first document set and a second document set, on the basis of the degree of similarity between each of at least one or all of documents included in the first document set and each of at least one or all of documents included in the second document set. For example, the selection section 213 may calculate, as the degree of similarity between a first document set and a second document set, the average of the degrees of similarity between each document included in the first document set and each document included in the second document set.

According to the present example embodiment, the sales support apparatus 20 calculates the degree of similarity between a first document and a second document on the basis of the degree of similarity between a first document set including a first document and a second document set including a second document. Since a cluster is selected on the basis of the similarity between document sets, it is possible to more accurately determine the condition of a business negotiation by using the sales support apparatus 20 in accordance with the present example embodiment.

### Fourth Example Embodiment

The following description will discuss in detail a fourth example embodiment of the present invention. Note that any constituent element that is identical in function to a constituent element described in any one(s) of the first to third example embodiments will be given the same reference numeral, and a description thereof will not be repeated.

In the present example embodiment, the clustering section 215 performs clustering on multiple second documents in accordance with attributes. For example, the attribute may indicate the type of industry of the corporate customer, the size of the corporate customer, the price range of the commercial material, the job title of the participant from the customer, the reaction of the customer, or the measure on one's own. For example, the clustering section 215 performs mapping of second documents in a predetermined feature area in accordance with multiple features including attributes of the second documents, and performs clustering on the multiple second documents in the feature space.

According to the present example embodiment, the sales support apparatus 20 performs clustering on the multiple second documents in accordance with attributes. This enables the sales support apparatus 20 to more accurately determine the condition of a business negotiation.

### [Software Implementation Example]

Some or all of the functions of the sales support apparatuses 10, 20 and the user terminal 30 (hereinafter, referred to as the “sales support apparatus 10 etc.”) can be realized by hardware such as an integrated circuit (IC chip) or can be alternatively realized by software.

In the latter case, the sales support apparatus 10 etc. are realized by, for example, a computer that executes instructions of a program that is software realizing the foregoing functions. FIG. 8 illustrates an example of such a computer (hereinafter, referred to as “computer C”). The computer C includes at least one processor C1 and at least one memory C2. The memory C2 stores a program P for causing the computer C to function as the sales support apparatus 10 etc. In the computer C, the processor C1 reads the program P from the memory C2 and executes the program P, so that the functions of the sales support apparatus 10 etc. are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface for transmitting and receiving data to and from other devices. The computer C may further include an input-output interface for connecting input-output devices such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium may be, for example, a communications network, a broadcast wave, or the like. The computer C can obtain the program P also via such a transmission medium.

### [Additional Remark 1]

The present invention is not limited to the above example embodiments, but can be altered in various ways by a person skilled in the art within the scope of the claims. For example, the present invention also encompasses, in its technical scope, any example embodiment derived by appropriately combining technical means disclosed in the foregoing example embodiments.

### [Additional Remark 2]

Some or all of the above example embodiments can be described as below. Note however that the present invention is not limited to example aspects described below.

### (Supplementary Note 1)

A sales support apparatus including:
obtaining means that obtains a first document in which contents of a first business negotiation are described in a natural language;
selection means that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and
output means that outputs information indicative of a condition of a business negotiation, the information being associated with the cluster selected by the selection means.

With this configuration, the sales support apparatus selects a cluster on the basis of the similarity between documents in each of which the contents of a business negotiation are described in a natural language. Thus, it is possible to more accurately determine the condition of a business negotiation.

### (Supplementary Note 2)

The sales support apparatus according to Supplementary note 1, further including clustering means that performs clustering on the documents accumulated in the storage device, in accordance with degrees of similarity between documents, to form the multiple clusters.

With this configuration, the sales support apparatus forms multiple clusters by performing clustering on the second documents in accordance with the degrees of similarity between documents, and selects a cluster on the basis of the similarity between the first document and the second document from among the formed clusters. This enables the sales support apparatus to more accurately determine the condition of a business negotiation.

### (Supplementary Note 3)

The sales support apparatus according to Supplementary note 2, wherein the clustering means performs clustering on the second documents in accordance with attributes of the second documents.

With this configuration, the sales support apparatus selects a cluster from among the clusters formed by the clustering in accordance with attributes of the second documents. This enables the sales support apparatus to more accurately determine the condition, taking into consideration the attributes of the second documents.

### (Supplementary Note 4)

The sales support apparatus according to any one of Supplementary notes 1 to 3, further including:
accepting means that accepts, for each of the multiple clusters, input of the information indicative of a condition of a business negotiation; and
information attaching means that stores the information accepted by the accepting means in a storage device, in association with information for identifying the cluster.

With this configuration, the sales support apparatus accepts input of the information indicative of the condition of a business negotiation for each of the multiple clusters, and stores the accepted information in the storage device in association with the information for identifying the cluster. Since the information is attached to a cluster unit of the second documents rather than to all the second documents, it is possible to reduce the processing cost required in attaching information.

### (Supplementary Note 5)

The sales support apparatus according to any one of Supplementary notes 1 to 4, wherein the selection means calculates, as the degree of similarity, a distance in a predetermined feature space between the first document and each of the second documents.

With this configuration, the sales support apparatus selects a cluster on the basis of the distances in a predetermined feature space between documents, so that it is possible to more accurately determine the condition of a business negotiation.

### (Supplementary Note 6)

The sales support apparatus according to any one of Supplementary notes 1 to 5, wherein
the selection means selects one or more second documents such that the degree of similarity satisfies a predetermined condition, from among the second documents, and
the selection means selects a cluster to which at least one or all of the one or more selected second documents belong, from among the multiple clusters.

With this configuration, the sales support apparatus selects, from among the multiple clusters, a cluster to which a second document belongs, such that the degree of similarity to the first document satisfies a predetermined condition. This enables the sales support apparatus to more appropriately determine the condition of the business negotiation of the first document.

### (Supplementary Note 7)

The sales support apparatus according to any one of Supplementary notes 1 to 6, wherein the selection means calculates a degree of similarity between the document obtained by the obtaining means and a second document that is representative of each of the multiple clusters and is included in the cluster, and selects a cluster, referring to the calculated degree of similarity.

With this configuration, the sales support apparatus selects a cluster on the basis of the degree of similarity between the first document and the second document representative of each cluster. This enables the sales support apparatus to more appropriately determine the condition of the business negotiation of the first document.

### (Supplementary Note 8)

The sales support apparatus according to any one of Supplementary notes 1 to 7, wherein
the obtaining means further obtains a third document created regarding the first business negotiation before the first document is created,
the second documents are subjected to clustering with reference to each second document and a fourth document created regarding the same second business negotiation as the second document describes before the second document is created, and
the selection means calculates a degree of similarity between the first document and each second document, on the basis of a degree of similarity between a document set including the first document and the third document, and a document set including the second document and the fourth document.

With this configuration, the sales support apparatus calculates the degree of similarity between the first document and the second document on the basis of the degree of similarity between the document set including the first document and the document set including the second document. Since the cluster is selected on the basis of the similarity between document sets, it is possible to more accurately determine the condition of a business negotiation.

### (Supplementary Note 9)

A sales supporting method including:
obtaining, by the sales support apparatus, a first document in which contents of a first business negotiation are described in a natural language;
by the sales support apparatus, referring, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selecting a cluster from among multiple clusters formed in clustering of the second documents, on the basis of a degree of similarity between the first document and each of at least one or all of the second documents; and
outputting, by the sales support apparatus, information indicative of a condition of a business negotiation, the information being associated with the selected cluster.

### (Supplementary Note 10)

A program for causing a computer to function as a sales support apparatus, the program causing the computer to function as:
obtaining means that obtains a first document in which contents of a first business negotiation are described in a natural language;
selection means that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and
output means that outputs information indicative of a condition of a business negotiation, the information being associated with the cluster selected by the selection means.

### [Additional Remark 3]

Some or all of the above example embodiments can also be described as below.

A sales support apparatus including at least one processor, the processor carrying out:
an obtaining process of obtaining a first document in which contents of a first business negotiation are described in a natural language;
a selection process of referring, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selecting a cluster from among multiple clusters formed in clustering of the second documents, on the basis of a degree of similarity between the first document and each of at least one or all of the second documents; and
an output process of outputting information indicative of a condition of a business negotiation, the information being associated with the cluster selected in the selection process.

Note that the sales support apparatus may further include a memory, which may store therein a program for causing the at least one processor to carry out the obtaining process, the selection process, and the output process. The program may be stored in a computer-readable, non-transitory, tangible storage medium.

### REFERENCE SIGNS LIST

1 Business negotiation management system
10, 20 Sales support apparatus
11, 211 Obtaining section
12, 213 Selection section
13, 214 Output section
30 User terminal
31 Input section
32 Display section
33, 230 Communication section
210 Control section
212 Calculation section
215 Clustering section
216 Accepting section
217 Information attaching section
220 Storage section
S10, S20 Sales supporting method

What is claimed is:

1. A sales support apparatus comprising at least one processor, the at least one processor carrying out:
an obtaining process that obtains a first document in which contents of a first business negotiation are described in a natural language;
a selection process that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and
an output process that outputs information indicative of a condition of a business negotiation, the information being associated with the cluster selected in the selection process.

2. The sales support apparatus according to claim 1, the at least one processor further carrying out a clustering process that performs clustering on the second documents in accordance with degrees of similarity between documents, to form the multiple clusters.

3. The sales support apparatus according to claim 2, wherein, in the clustering process, the at least one processor performs clustering on the second documents in accordance with attributes of the second documents.

4. The sales support apparatus according to claim 1, the at least one processor further carrying out:
an accepting process that accepts, for each of the multiple clusters, input of the information indicative of a condition of a business negotiation; and
an information attaching process that stores the information accepted in the accepting process in a storage device, in association with information for identifying the cluster.

5. The sales support apparatus according to claim 1, wherein, in the selection process, the at least one processor calculates, as the degree of similarity, a distance in a predetermined feature space between the first document and each of the second documents.

6. The sales support apparatus according to claim 1, wherein
in the selection process, the at least one processor
selects one or more second documents such that the degree of similarity satisfies a predetermined condition, from among the second documents, and
selects a cluster to which at least one or all of the one or more selected second documents belong, from among the multiple clusters.

7. The sales support apparatus according to claim 1, wherein, in the selection process, the at least one processor calculates a degree of similarity between the first document and a second document that is representative of each of the multiple clusters and is included in the cluster, and selects a cluster, referring to the calculated degree of similarity.

8. The sales support apparatus according to claim 1, wherein
in the obtaining process, the at least one processor further obtains a third document created regarding the first business negotiation before the first document is created,
the second documents are subjected to clustering with reference to each second document and a fourth document created regarding the same second business negotiation as the second document describes before the second document is created, and
in the selection process, the at least one processor calculates a degree of similarity between the first document and each second document, on the basis of a degree of similarity between a document set including the first document and the third document, and a document set including the second document and the fourth document.

9. A sales supporting method comprising:
obtaining, by the sales support apparatus, a first document in which contents of a first business negotiation are described in a natural language;
by the sales support apparatus, referring, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selecting a cluster from among multiple clusters formed in clustering of the second documents, on the basis of a degree of similarity between the first document and each of at least one or all of the second documents; and
outputting, by the sales support apparatus, information indicative of a condition of a business negotiation, the information being associated with the selected cluster.

10. A non-transitory storage medium storing a program for causing a computer to function as a sales support apparatus, the program causing the computer to carry out:
an obtaining process that obtains a first document in which contents of a first business negotiation are described in a natural language;
a selection process that refers, for each of multiple second business negotiations that are other than the first business negotiation, to a storage device storing: a second document in which contents of the second business negotiation are described in a natural language; information on a cluster to which the second document belongs; and a business negotiation condition indicated in a document belonging to the cluster, and selects a cluster from among multiple clusters formed in clustering of the second documents, on the basis of a degree of similarity between the first document and each of at least one or all of the second documents; and
an output process that outputs information indicative of a condition of a business negotiation, the information being associated with the cluster selected in the selection process.
